(19) United States
(12) Patent Application Publication
(10) Pub. No.: US 2007/0152552 A1
(43) Pub. Date: Jul. 5, 2007

(54) FILTERING DEVICE AND PROJECTOR UTILIZING THE SAME

(75) Inventors: Fu-Shiung Shih, Taichung (TW); Shih-Pin Chen, Taoyuan County (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/616,239

(22) Filed: Dec. 26, 2006

(30) Foreign Application Priority Data
Dec. 29, 2005 (TW) TW94147218

(51) Int. Cl. H01J 7/24; F21V 7/20; G05D 23/00

(52) U.S. Cl. 313/13; 165/291; 362/345

(57) ABSTRACT

A filtering device and a projector utilizing the same. The filtering device receives an electronic device therein, and includes a housing, a filter, a fan, a first temperature sensor, a second temperature sensor, a circuit board, and an alarm. The first temperature sensor detects a first temperature outside the housing. The second temperature sensor detects a second temperature inside the housing. The circuit board includes a controller to be coupled to the fan, the first temperature sensor, and the second temperature sensor. When the second temperature detected by the second temperature sensor exceeds the first temperature detected by the first temperature sensor, the voltage of the fan is increased by the controller to increase the rotation speed of the fan. The alarm is coupled to the controller. When the voltage of the fan exceeds a critical value, the alarm is actuated to indicate that the filter needs to be changed.

### BACKGROUND OF THE INVENTION

1. Field of the Invention

The present invention relates to a filtering device and a projector utilizing the same, and in particular, to a filtering device with a mechanism to assist in the replacement of its filter.

2. Description of the Related Art

Since electronic devices, such as projectors, typically generate heat during operation, air convection is necessary for cooling. Fine particles, such as dust in the air, may, however, be sucked into the electronic device, thus causing damage. As a result, a filtering device capable of filtering fine particles is necessary.

FIG. 1 is a schematic view of a conventional filtering device 10. A filter 12 is disposed at an inlet 11a of a housing 11. A fan 13 and a device 1 to be cooled are disposed in the housing 11. The fan 13 draws the air A into the housing 11, and the filter 12 filters particles P in the air A. Since the filter 12 may be obstructed by the particles P, it must be replaced at a predetermined time to maintain normal air convection.

Nevertheless, since the conventional filtering device does not comprise a mechanism to assist in the replacement of the filter, it might not be easy for a user to replace the filter, and, as a result, the filter may not be replaced at the appropriate time.

### BRIEF SUMMARY OF THE INVENTION

Filtering devices are provided. An exemplary embodiment of a filtering device receives an electronic device therein, and comprises a housing, a filter, a fan, a first temperature sensor, a second temperature sensor, a circuit board, and an alarm. The fan is disposed in the housing. The filter is disposed on the housing. The first temperature sensor is disposed outside the housing to detect a first temperature outside the housing. The second temperature sensor is disposed inside the housing to detect a second temperature inside the housing. The circuit board comprises a controller to couple to the fan, the first temperature sensor, and the second temperature sensor. When the second temperature detected by the second temperature sensor exceeds the first temperature detected by the first temperature sensor, the voltage of the fan is increased by the controller to increase the rotation speed of the fan. The alarm is coupled to the controller. When the voltage of the fan exceeds a critical value, the alarm is actuated to indicate that the filter needs to be changed.

Furthermore, when the second temperature detected by the second temperature sensor is lower than the first temperature detected by the first temperature sensor, the voltage of the fan is reduced by the controller to decrease the rotation speed of the fan.

Additionally, both the first and second temperature sensors are thermistors. The alarm may be a light or an audio device.

Projectors are provided. An exemplary embodiment of a projector comprises the filtering device and a projecting module disposed in the filtering device.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional filtering device;

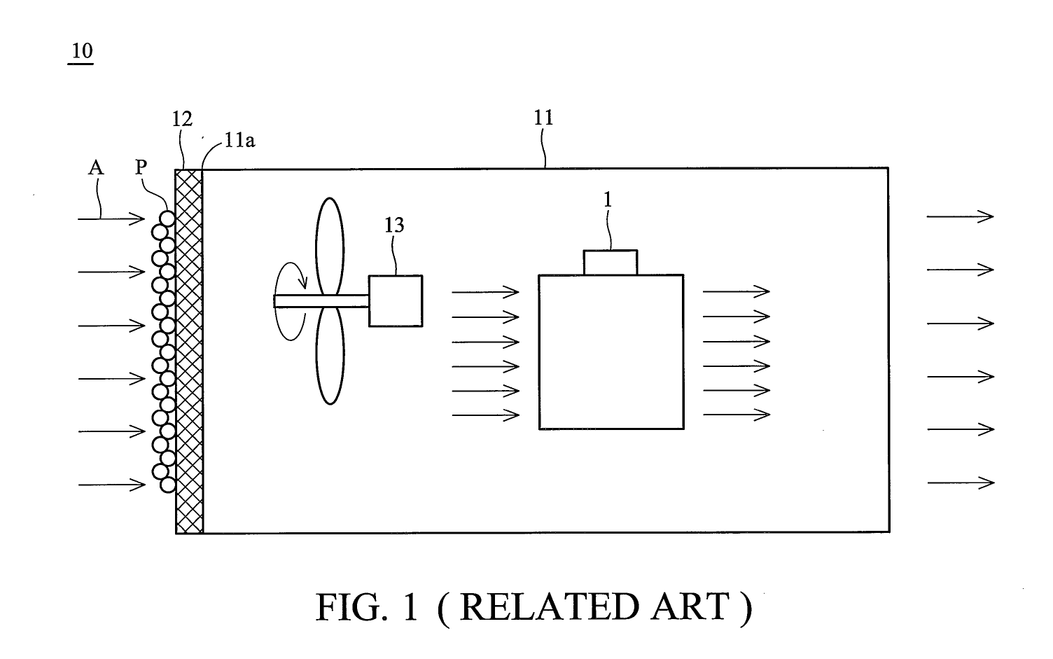

FIG. 2 is a schematic view of an embodiment of a filtering device of this invention; and

FIG. 3 is a flowchart depicting replacement of a filter of the filtering device in FIG. 2.

### DETAILED DESCRIPTION OF THE INVENTION

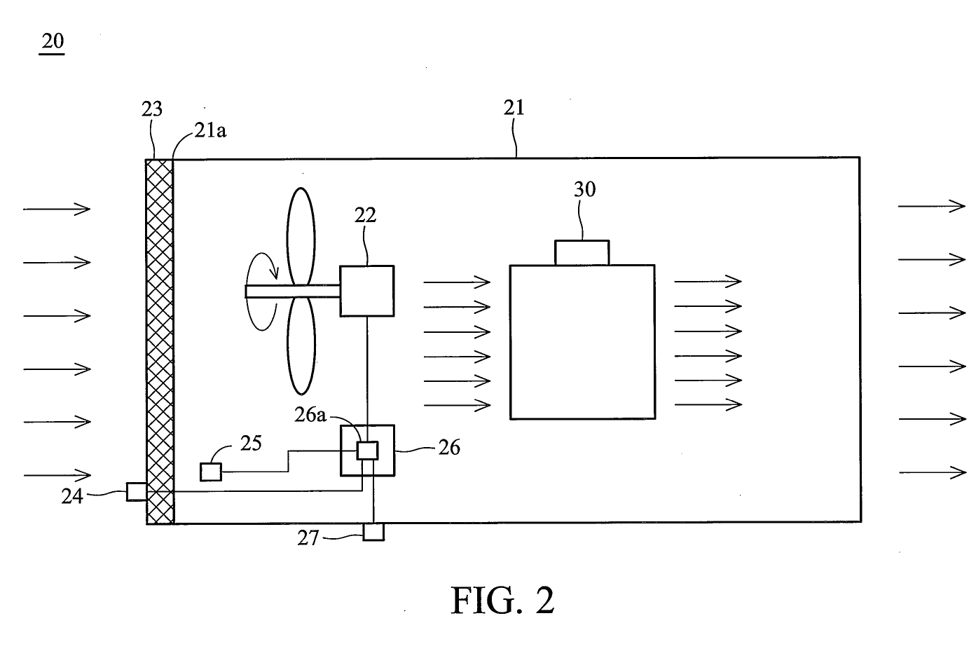

Referring to FIG. 2, an embodiment of a filtering device 20 receives an electronic device 30 therein, and comprises a housing 21, a fan 22, a filter 23, a first temperature sensor 24, a second temperature sensor 25, a circuit board 26, and an alarm 27.

The fan 22 is disposed in the housing 21, and is located near an inlet 21a of the housing 21 to generate an air flow in the housing 21, thus decreasing the temperature inside the housing 21. The filter 23 is disposed at the inlet 21 a of the housing 21 to filter the air flowing into the housing 21.

The first temperature sensor 24 is disposed outside the housing 21 to detect a first temperature outside the housing 21 (i.e. atmosphere temperature). The second temperature sensor 25 is disposed inside the housing 21 to detect a second temperature inside the housing 21. Furthermore, both the first and second temperature sensors 24 and 25 may be thermistors respectively for accurate detection. Additionally, although the first temperature sensor 24 is disposed on the filter 23 in FIG. 2, it is not limited to this as long as the utilized sensor can detect the temperature outside the housing 21.

The circuit board 26 is disposed in the housing 21, and comprises a controller 26a to couple to the fan 22, the first temperature sensor 24, and the second temperature sensor 25. When the second temperature detected by the second temperature sensor 25 exceeds the first temperature detected by the first temperature sensor 24, the voltage of the fan 22 is increased by the controller 26a to increase the rotation speed of the fan 22. When the second temperature detected by the second temperature sensor 25 is lower than the first temperature detected by the first temperature sensor 24, the voltage of the fan 22 is reduced by the controller 26a to decrease the rotation speed of the fan 22.

The alarm 27 may be a light, and is disposed at a predetermined position on an outer surface of the housing 21 to be coupled to the controller 26a. When the voltage of the fan 22 exceeds a critical value, the light is actuated to show that the filter 23 needs changing. Additionally, the alarm may be an audio device to generate a noise to indicate that the filter needs to be replaced.

The electronic device 30 may be a projecting module to be combined with the filtering device 20 to constitute a projector.

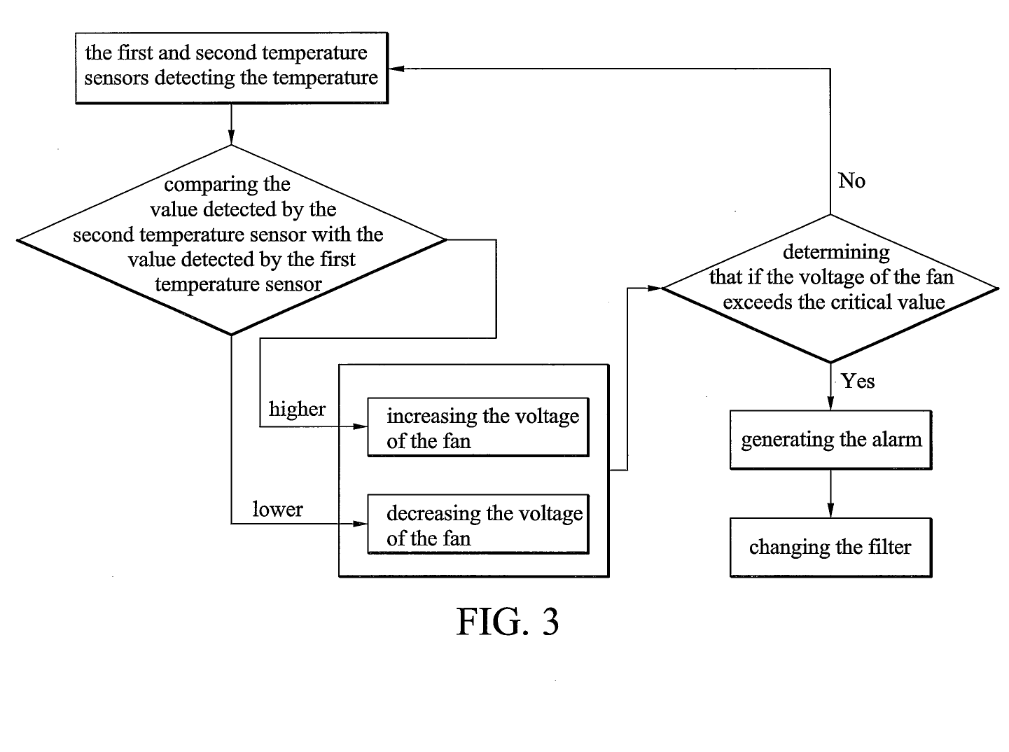

FIG. 3 is a flowchart depicting replacement of the filter 23 of the filtering device 20 in FIG. 2. To determine that if the filter 23 needs to be changed, the first and second temperature sensors 24 and 25 first detect the surrounding temperature respectively. When the second temperature detected by the second temperature sensor 25 exceeds the first temperature detected by the first temperature sensor 24, the voltage of the fan 22 is increased by the controller 26a to increase the rotation speed of the fan 22 until the temperature inside the filtering device 20 is the same as the temperature outside the filtering device 20. Conversely, when the second temperature detected by the second temperature sensor 25 is lower than the first temperature detected by the first temperature sensor 24, the voltage of the fan 22 is reduced by the controller 26a to decrease the rotation speed of the fan 22 until the temperature inside the filtering device 20 is the same as the temperature outside the filtering device 20. Furthermore, when the filter 23 is gradually obstructed by the accumulation of dust, air convection efficiency is reduced, and higher voltage must be applied to the fan 23 to obtain a higher rotation speed to reduce the increasing temperature inside the filtering device 20. In case of the voltage applied to the fan 22 exceeding the critical value, the alarm 27 is actuated to indicate that the filter 23 needs to be changed.

As previously described, since the filtering device comprises a mechanism to assist in the replacement of the filter, hence, the filter may be replaced at the appropriate time.

While the invention has been described by way of example and in terms of, preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A filtering device for receiving an electronic device therein, comprising:
a housing;
a fan disposed in the housing;
a filter disposed on the housing;
a first temperature sensor disposed outside the housing to detect a first temperature outside the housing;
a second temperature sensor disposed inside the housing to detect a second temperature inside the housing;
a circuit board comprising a controller to couple to the fan, the first temperature sensor, and the second temperature sensor, wherein a voltage of the fan is increased by the controller to increase a rotation speed of the fan when the second temperature detected by the second temperature sensor exceeds the first temperature detected by the first temperature sensor; and
an alarm coupled to the controller, wherein the alarm is actuated when the voltage of the fan exceeds a critical value.

2. The filtering device as claimed in claim 1, wherein the voltage of the fan is reduced by the controller to decrease the rotation speed of the fan when the second temperature detected by the second temperature sensor is lower than the first temperature detected by the first temperature sensor.

3. The filtering device as claimed in claim 1, wherein the second temperature sensor is a thermistor.

4. The filtering device as claimed in claim 3, wherein the first temperature sensor is a thermistor.

5. The filtering device as claimed in claim 1, wherein the alarm is a light.

6. The filtering device as claimed in claim 1, wherein the alarm is an audio device.

7. A projector comprising:
a filtering device; and
a projecting module disposed in the filtering device;
wherein the filtering device comprises:
a housing receiving the projecting module therein;
a fan disposed in the housing;
a filter disposed on the housing;
a first temperature sensor disposed outside the housing to detect a first temperature outside the housing;
a second temperature sensor disposed inside the housing to detect a second temperature inside the housing;
a circuit board comprising a controller to couple to the fan, the first temperature sensor, and the second temperature sensor, wherein a voltage of the fan is increased by the controller to increase a rotation speed of the fan when the second temperature detected by the second temperature sensor exceeds the first temperature detected by the first temperature sensor; and
an alarm coupled to the controller, wherein the alarm is actuated when the voltage of the fan exceeds a critical value.

8. The projector as claimed in claim 7, wherein the voltage of the fan is reduced by the controller to decrease the rotation speed of the fan when the second temperature detected by the second temperature sensor is lower than the first temperature detected by the first temperature sensor.

9. The projector as claimed in claim 7, wherein the second temperature sensor is a thermistor.

10. The projector as claimed in claim 9, wherein the first temperature sensor is a thermistor.

11. The projector as claimed in claim 7, wherein the alarm is a light.

12. The projector as claimed in claim 7, wherein the alarm is an audio device.
